(19) United States
(12) Patent Application Publication
(10) Pub. No.: US 2021/0040713 A1
(43) Pub. Date: Feb. 11, 2021

(54) SYSTEM AND METHOD FOR DETERMINING WORK OF WORK VEHICLE, AND METHOD FOR PRODUCING TRAINED MODEL

(71) Applicant: KOMATSU LTD., Tokyo (JP)

(72) Inventors: Nobuyoshi YAMANAKA, Minato-ku, Tokyo (JP); Kensuke FUJII, Tokyo (JP)

(21) Appl. No.: 16/967,012

(22) PCT Filed: Mar. 19, 2019
(86) PCT No.: PCT/JP2019/011521

§ 371 Date: Aug. 3, 2020

(30) Foreign Application Priority Data
Jun. 28, 2018 (JP) 2018-123196

(51) Int. Cl. E02F 9/26; G06T 7/00; G06N 3/08

(52) U.S. Cl. CPC E02F 9/261; E02F 9/264; G06T 2207/20081; G06N 3/08; G06T 2207/10016; G06T 7/0004

(57) ABSTRACT

A system determines work executed by a work vehicle that includes a vehicle body and a work implement movably attached to the vehicle body. The system includes a camera attached to the vehicle body, and a processor. The camera is disposed to be oriented from the vehicle body toward a working position of the work implement, and generates image data indicative of images of the working position captured in a time sequence. The processor has a trained model in order to output a classification of the work corresponding to the image data. The image data serves as input data. The processor acquires the image data, and determines the classification of the work from the image data by image analysis using the trained model.

### CROSS-REFERENCE TO RELATED APPLICATIONS

This application is a U.S. National stage application of International Application No. PCT/JP2019/011521, filed on Mar. 19, 2019. This U.S. National stage application claims priority under 35 U.S.C. § 119(a) to Japanese Patent Application No. 2018-123196, filed in Japan on Jun. 28, 2018, the entire contents of which are hereby incorporated herein by reference.

### BACKGROUND

### Field of the Invention

The present invention relates to a system and a method for determining work of a work vehicle, and a method for producing a trained model.

### Background Information

A technique for estimating work performed by a work vehicle with a computer is known in the prior art. For example, a hydraulic excavator performs actions such as excavating, slewing, and earth removal. In Japanese Patent Laid-open No. 2016-103301, the above types of work performed by the hydraulic excavator are determined by a controller based on detection values from sensors provided on the hydraulic excavator. For example, the hydraulic excavator is provided with a rotation speed sensor, a pressure sensor, and a plurality of angle sensors. The rotation speed sensor detects the rotation speed of the engine. The pressure sensor detects the discharge pressure of a hydraulic pump. The plurality of angle sensors detects the boom angle, the arm angle, and the bucket angle. The controller determines the work being executed by the hydraulic excavator based on the detection values from the sensors.

### SUMMARY

However, the work of a work vehicle not provided with the sensors cannot be determined with the above technology. In addition, when determining the actions of a plurality of work vehicles deployed at a work site in order to manage the work vehicles, not all of the work vehicles are provided with the sensors necessary for determining the work. Therefore, it is not easy to determine the work of a plurality of work vehicles deployed at a work site in order to manage the work vehicles.

Recently, studies have been carried out on techniques for allowing a computer to determine what type of action is being performed by using artificial intelligence to analyze moving images that capture the actions of a human or an object. For example, technologies such as recursive neural networks (RNN) have been studied as models of artificial intelligence that deal with moving images. By using such artificial intelligence technologies, the actions of a work vehicle can be determined by a computer if moving images that capture the actions of the work vehicle can be analyzed.

However, when images of a work vehicle are captured by a camera disposed on the outside of the work vehicle, the acquired moving images differ according to the orientation of the work vehicle even when the work is the same. Therefore, in order to train a model of artificial intelligence, it is necessary to acquire a large amount of moving images in which the orientation of the work vehicle is changed. As a result, it is not easy to build a trained model with high determination accuracy.

An object of the present invention is to determine work of a work vehicle easily and with high accuracy using artificial intelligence.

A first aspect is a system for determining work executed by a work vehicle. The work vehicle includes a vehicle body and a work implement movably attached to the vehicle body. The system of the present aspect includes a camera and a processor. The camera is attached to the vehicle body and is disposed to be oriented from the vehicle body toward a working position of the work implement. The camera generates image data indicative of images that capture the working position in a time sequence. The processor has a trained model. The trained model outputs a classification of the work corresponding to the image data with the image data serving as input data. The processor acquires the image data and determines the classification of the work from the image data by image analysis using the trained model.

A second aspect is a method executed with a computer in order to determine work executed by a work vehicle. The work vehicle includes a vehicle body and a work implement movably attached to the vehicle body. The method according to the present aspect includes the following processes. A first process is acquiring, from a camera fixedly disposed on the vehicle body and oriented toward a working position of the work implement, image data indicative of images that capture the working position in a time sequence. A second process is determining a classification of the work from the image data by performing image analysis using a trained model. The trained model outputs the classification of the work corresponding to the image data with the image data serving as input data.

A third aspect is a method for producing a trained model for determining work executed by a work vehicle. The work vehicle includes a vehicle body and a work implement movably attached to the vehicle body. The method for producing the trained model according to the present aspect includes the following processes. A first process is acquiring image data indicative of images that are oriented from the vehicle body toward a working position of the work implement and that capture the working position in a time sequence. A second process is generating work data that includes time points in the images and a classification of the work ascribed to each time point. A third process is building a trained model by training a model for image analysis using the image data and the work data as training data.

In the present invention, image data is acquired from a camera disposed on the vehicle body and oriented toward the working position of the work implement. Therefore, even if the orientation of the work vehicle changes, changes in the positional relationship between the working position and the camera in the images are few. As a result, a trained model with high determination accuracy can be easily built. Consequently, the work of a work vehicle can be determined easily and with high accuracy using artificial intelligence.

### BRIEF DESCRIPTION OF DRAWINGS

FIG. 1 is a schematic view of a system according to an embodiment.

FIG. 2 is a schematic view of a configuration of a computer of the system.

FIG. 3 is a schematic view of a configuration of the system loaded in the computer.

FIG. 4 is a schematic view of a configuration of a neural network.

FIG. 5 is a flow chart of processing for estimating the work of a work vehicle.

FIG. 6 illustrates examples of image data of excavating.

FIG. 7 illustrates examples of image data of hoist slewing.

FIG. 8 illustrates examples of image data of unloading.

FIG. 9 illustrates examples of image data of unloaded slewing.

FIG. 10 is a schematic view of a configuration of a training system.

FIG. 11 illustrates an example of work data.

### DETAILED DESCRIPTION OF EMBODIMENT(S)

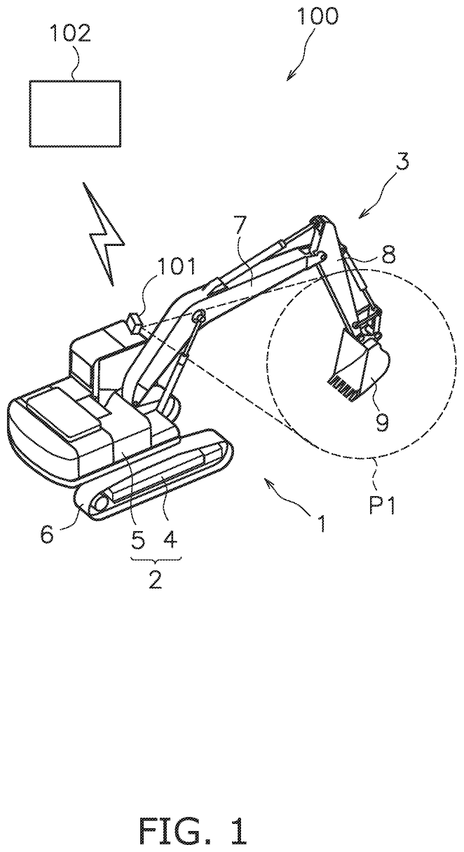

The following is an explanation of an embodiment with reference to the accompanying drawings. FIG. 1 is a schematic view of a classifying system 100 according to an embodiment. The classifying system 100 is a system for determining work performed by a work vehicle 1. The work vehicle 1 is a hydraulic excavator in the present embodiment. The work vehicle 1 includes a vehicle body 2 and a work implement 3.

The vehicle body 2 includes a carriage 4 and a slewing body 5. The carriage 4 includes crawler belts 6. The work vehicle 1 travels due to the crawler belts 6 being driven. The slewing body 5 is attached to the carriage 4 to allow for slewing. The work implement 3 is movably attached to the vehicle body 2. Specifically, the work implement 3 is rotatably attached to the slewing body 5. The work implement 3 includes a boom 7, an arm 8, and a bucket 9. The boom 7 is rotatably attached to the slewing body 5. The arm 8 is rotatably attached to the boom 7. The bucket 9 is rotatably attached to the arm 8.

The classifying system 100 includes a camera 101 and a computer 102. The camera 101 is attached to the vehicle body 2. Specifically, the camera 101 is attached to the slewing body 5. The camera 101 is disposed to be oriented from the vehicle body 2 toward a working position P1 of the work implement 3. The orientation of the camera 101 is fixed with respect to the vehicle body 2. The working position P1 includes at least a portion of the work implement 3 and a predetermined range that includes the surroundings of the portion.

Specifically, the working position P1 includes the bucket 9 and the periphery thereof. Therefore, image data includes video of the actions of the bucket 9. In addition, the image data includes video of the background of the bucket 9. The working position P1 may also include at least a portion of the arm 8. The camera 101 generates the image data indicative of images that capture the working positions P1 in a time sequence. Specifically the camera 101 generates moving image data that captures the working positions P1.

The computer 102 communicates by wire or wirelessly with the camera 101. The camera 101 transmits the image data to the computer 102. The computer 102 may receive the image data from the camera 101 over a communication network. The computer 102 may receive the image data from the camera 101 via a recording medium.

The computer 102 may be disposed in a work site where the work vehicle 1 is present. Alternatively, the computer 102 may be disposed in a management center separate from the work site. The computer 102 may be a unit that is dedicated to calculations for the classifying system 100 or may be a general personal computer (PC). The computer 102 receives the image data from the camera 101. The computer 102 determines the classification of the work of the work vehicle 1 from the image data by using a trained model of artificial intelligence.

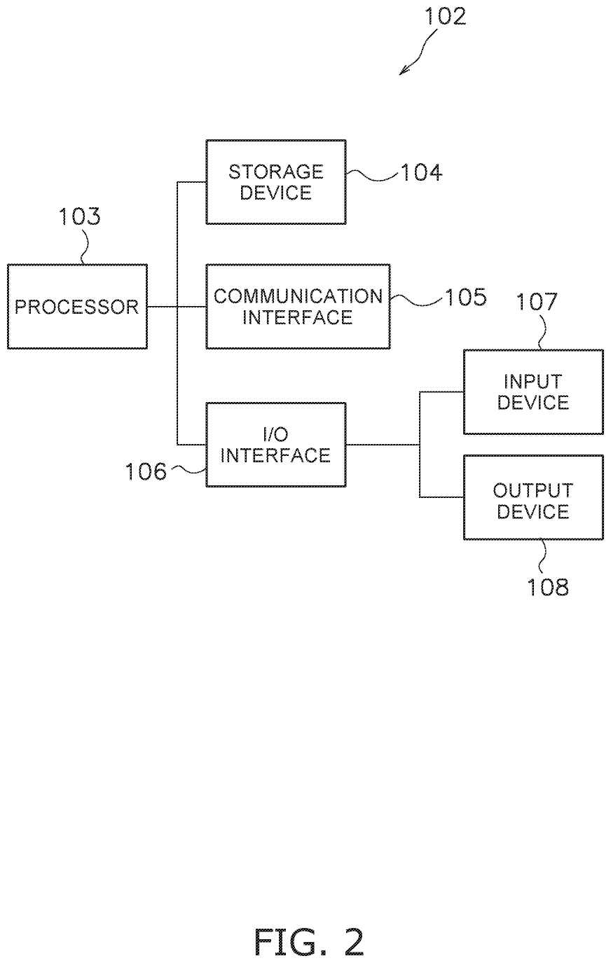

FIG. 2 is a schematic view of a configuration of the computer 102. As illustrated in FIG. 2, the computer 102 includes a processor 103, a storage device 104, a communication interface 105, and an I/O interface 106. The processor 103 may be, for example, a central processing unit (CPU). The storage device 104 includes a medium for recording information such as recorded programs or data in a form that can be read by the processor 103. The storage device 104 includes a system memory such as a random access memory (RAM) or a read-only memory (ROM), and an auxiliary storage device. The auxiliary storage device may be an electromagnetic recording medium such as a hard disk, an optical recording medium such as a CD or a DVD or the like, or a semiconductor memory such as a flash memory. The storage device 104 may be built into the computer 102. The storage device 104 may include an external recording medium that is detachably connected to the computer 102.

The communication interface 105 is, for example, a wired local area network (LAN) module or a wireless LAN module, and is an interface for communicating over a communication network. The I/O interface 106 is, for example, a universal serial bus (USB) port and is an interface for connecting to an external device.

The computer 102 is connected to an input device 107 and an output device 108 via the I/O interface 106. The input device 107 is a device for a user to input data into the computer 102. The input device 107 includes, for example, a pointing device such as a mouse or a track ball. The input device 107 may include a device for inputting characters such as a keyboard. The output device 108 includes, for example, a display.

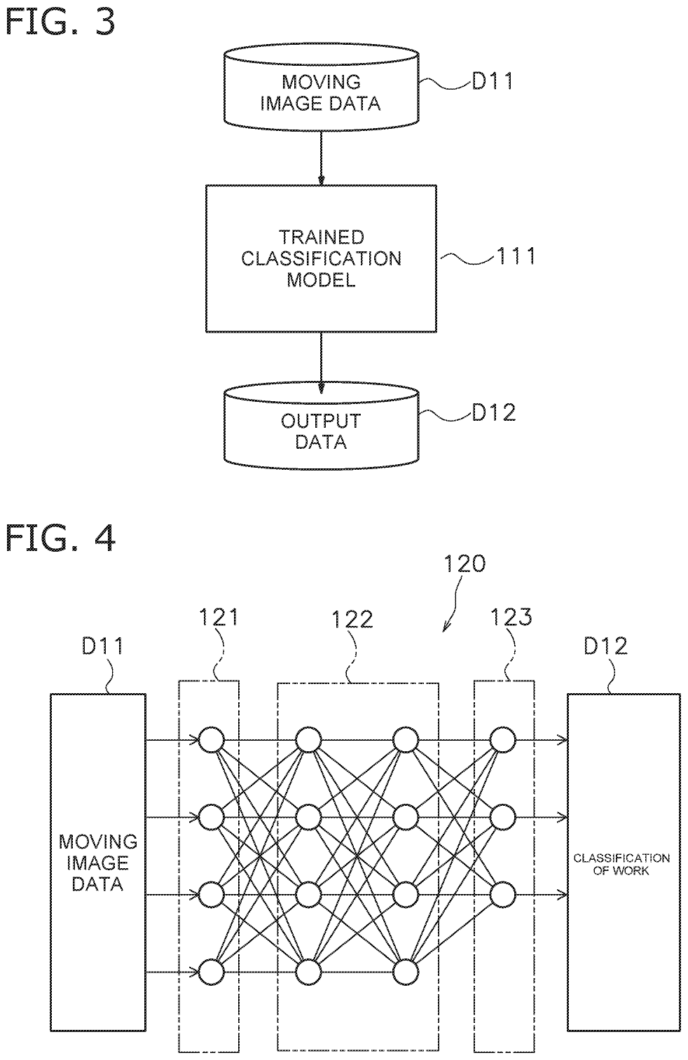

FIG. 3 illustrates a portion of a configuration of the classifying system 100. As illustrated in FIG. 3, the classifying system 100 includes a trained classification model 111. The trained classification model 111 is loaded in the computer 102. The trained classification model 111 may be saved in the storage device 104 of the computer 102.

In the present embodiment, the modules and models may be loaded in hardware, or in software, firmware that can be executed on the hardware, or a combination thereof. The modules and models may include programs, algorithms, and data that are executed by a processor. The functions of the modules and models may be executed by a single module or distributed among a plurality of modules and executed. The modules and models may be distributed and disposed among a plurality of computers.

The classification model 111 is an artificial intelligence model for image analysis. Specifically, the classification model 111 is an artificial intelligence model for moving image analysis. The classification model 111 analyzes inputted image data D11 and outputs a classification corresponding to the moving images in the image data D11. The computer 102 determines the classification of the work performed by the work vehicle 1 by executing the moving image analysis using the classification model 111 of the artificial intelligence on the image data D11. The classification model 111 outputs output data D12 indicative of the determined classification of the work.

The classification model 111 includes a neural network 120 illustrated in FIG. 4. For example, the classification model 111 includes a deep neural network such as a convolutional neural network (CNN).

As illustrated in FIG. 4, the neural network 120 includes an input layer 121, an intermediate layer 122 (hidden layer), and an output layer 123. The layers 121, 122, and 123 include one or more neurons. For example, the number of neurons in the input layer 121 can be set in accordance with the number of pixels in the image data D11. The number of neurons in the intermediate layer 122 can be set as appropriate. The output layer 123 can be set in accordance with the number of classifications of the work performed by the work vehicle 1.

The neurons of adjacent layers may be coupled together and weights (coupled loads) are set for each coupling. The number of neuron couplings may be set as appropriate. Thresholds are set for each neuron and an output value outputted by each neuron is determined according to whether the sum of the products of the input values to each neuron and the weights exceed the threshold.

The image data D11 of the work vehicle 1 is inputted to the input layer 121. Output values indicative of the probability of each classified action are outputted to the output layer 123. The classification model 111 is trained so that when the image data D11 is inputted, the output values indicative of the probability of each classified work are outputted. Trained parameters of the classification model 111 obtained by training are stored in the storage device 104. The trained parameters include, for example, the number of layers of the neural network 120, the number of neurons in each layer, the coupling relationships among the neurons, the weights of the couplings among neurons, and the thresholds of each neuron.

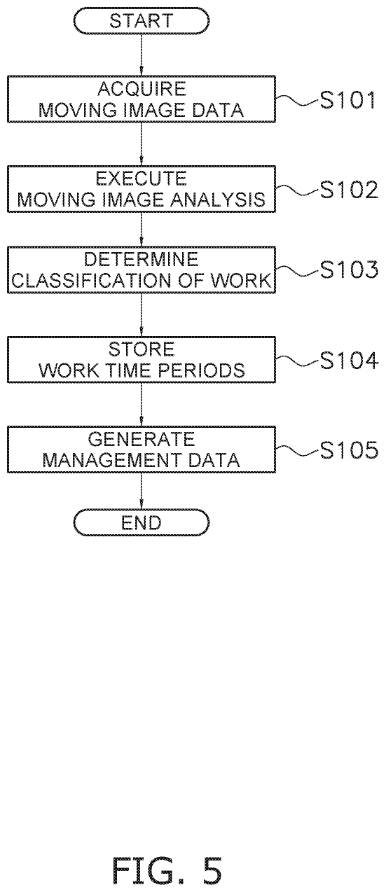

FIG. 5 is a flow chart of processing executed by the computer 102 (processor 103) for determining the work of the work vehicle 1. As illustrated in step S101 in FIG. 5, the computer 102 acquires the image data D11 of the work vehicle 1 captured by the camera 101. The computer 102 may acquire the image data D11 captured by the camera 101 in real time. Alternatively, the computer 102 may acquire the image data D11 captured by the camera 101 at predetermined time points or over predetermined time periods. The computer 102 saves the image data D11 in the storage device 104.

In step S102, the computer 102 executes moving image analysis using the trained classification model 111. The computer 102 uses moving images, indicative of the image data D11 acquired in step S101, as input data for the classification model 111 and executes image analysis based on the abovementioned neural network 120.

For example, the computer 102 inputs an image pixel included in the image data D11 in each neuron included in the input layer 121 of the neural network 120. The computer 102 derives, as the output data D12, a probability of each classification of work performed by the work vehicle 1. In the present embodiment, the classification of work includes “excavating,” “hoist slewing,” “unloading,” and “unloaded slewing.” Therefore, the computer 102 derives an output indicative of the probability of each classification of the “excavating,” “hoist slewing,” “unloading,” and “unloaded slewing.”

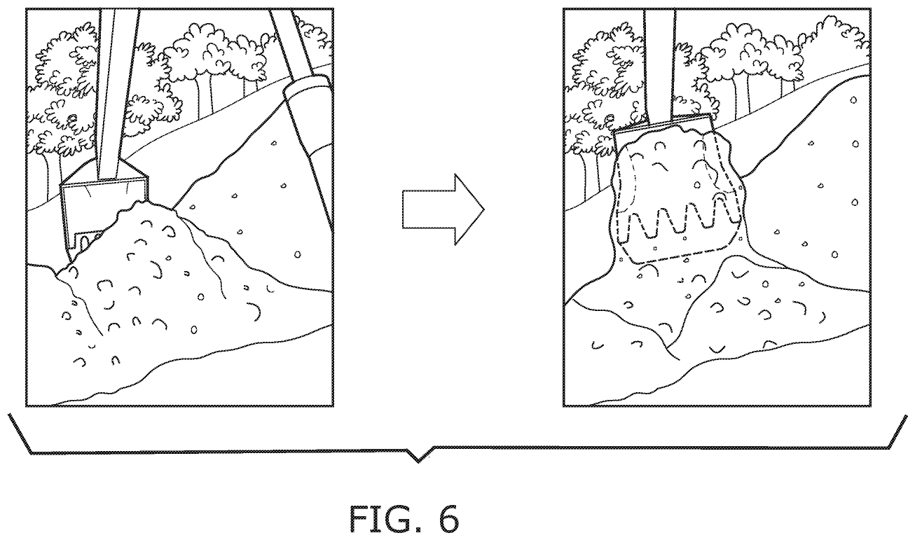

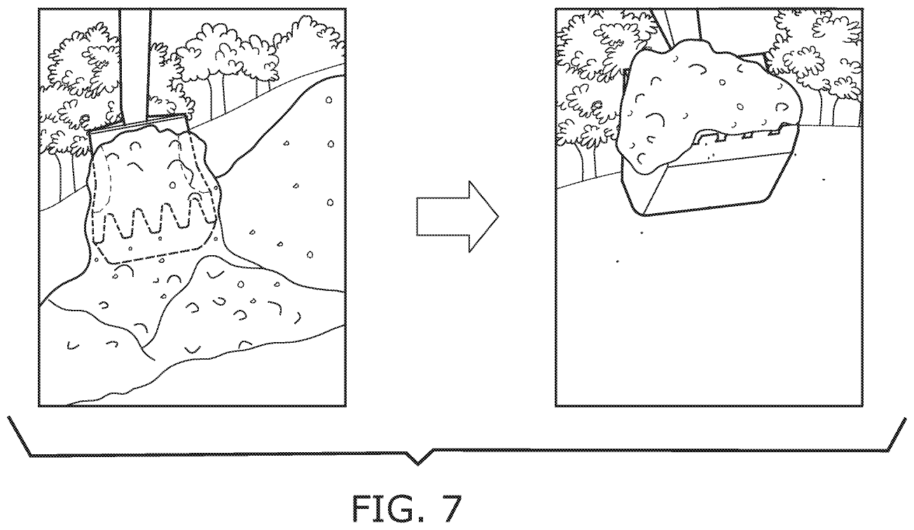

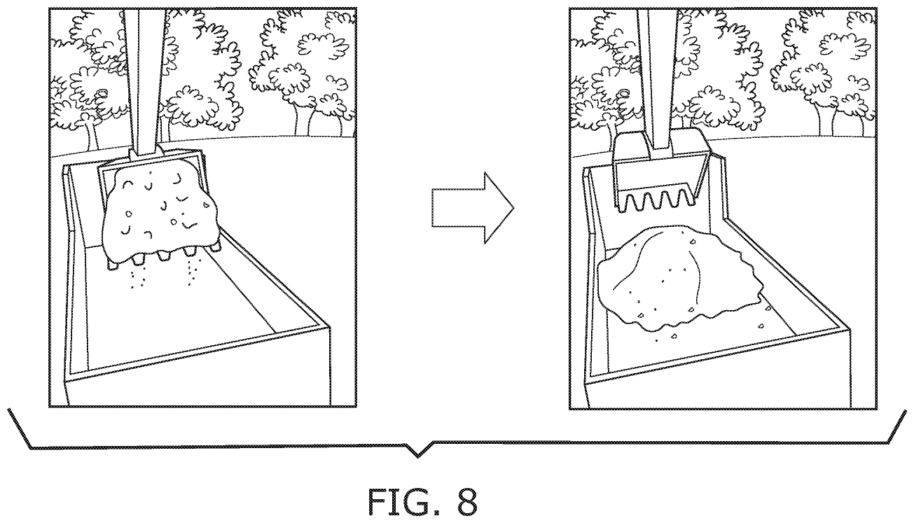

FIG. 6 illustrates examples of image data of “excavating” captured by the camera 101. As illustrated in FIG. 6, the image data of the excavating represents moving images of the actions of the bucket 9 rotating in the excavating direction and actions from the bucket 9 coming into contact with the earth until the bucket 9 moves away from the earth. FIG. 7 illustrates examples of image data of “hoist slewing” captured by the camera 101. As illustrated in FIG. 7, the image data of the hoist slewing represents moving images of the actions starting from the background of the bucket 9 continuously changing, due to the slewing body 5 slewing, until the changes stop.

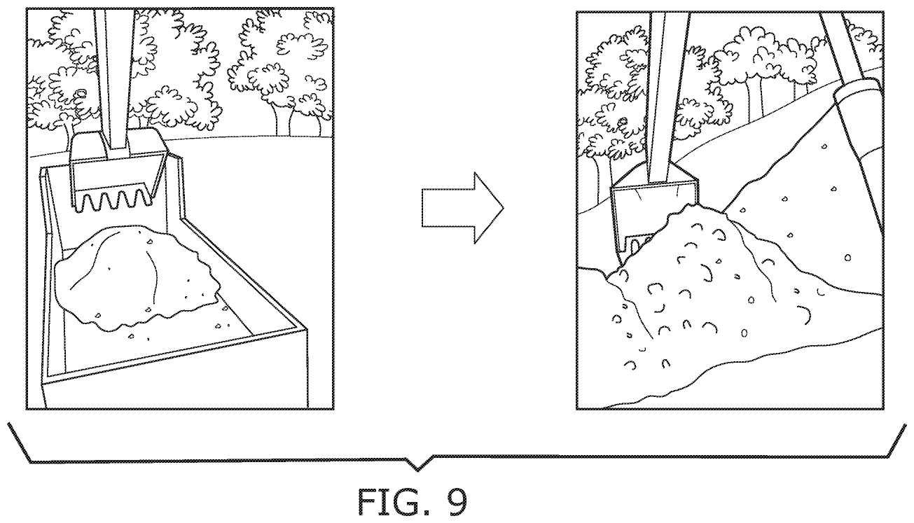

FIG. 8 illustrates examples of image data of “unloading” captured by the camera 101. As illustrated in FIG. 8, the image data of the unloading represents moving images of the actions of the bucket 9 rotating in the unloading direction and the actions from the bucket 9 starting to open until all of the earth is dropped from the bucket 9. FIG. 9 illustrates examples of image data of “unloaded slewing” captured by the camera 101. As illustrated in FIG. 9, the image data of the unloaded slewing represents moving images of the actions starting from the background of the bucket 9 continuously changing, due to the slewing body 5 slewing, until the changes stop. However, in the image data of the unloaded slewing, the attitude of the bucket 9 is different in comparison to the image data of the hoist slewing.

The classification model 111 is trained so that the output values of the classification of the “excavating” are higher in the image data indicative of the excavating as illustrated in FIG. 6. The classification model 111 is trained so that the output values of the classification of the “hoist slewing” are higher in the image data indicative of the hoist slewing as illustrated in FIG. 7. The classification model 111 is trained so that the output values of the classification of the “unloading” are higher in the image data indicative of the unloading as illustrated in FIG. 8. The classification model 111 is trained so that the output values of the classification of the “unloaded slewing” are higher in the image data indicative of the unloaded slewing as illustrated in FIG. 9.

In step S103, the computer 102 determines the classification of the work performed by the work vehicle 1. The computer 102 determines the classification of the work performed by the work vehicle 1 based on the probability of each classification represented by the output data D12. The computer 102 determines the classification that has the highest probability as the work of the work vehicle 1. As a result, the computer 102 estimates the work being executed by the work vehicle 1.

In step S104, the computer 102 records the work time periods of the work vehicle 1 for the classification determined in step S103. For example, when the work vehicle 1 is performing the excavating, the computer 102 determines that the classification of the work is “excavating” and records the work time period of the excavating.

In step S105, the computer 102 generates management data which includes the classification of the work and the work time period. The computer 102 records the management data in the storage device 104. The processing from steps S101 to S105 may be executed in real time during the work of the work vehicle 1. Alternatively, the processing from step S101 to step S105 may be executed after the work of the work vehicle 1 is completed.

In the classifying system 100 according to the present embodiment explained above, the image data is acquired from the camera 101 disposed on the vehicle body 2 and oriented toward the working position P1 of the work implement 3. The positional relationship between the working position P1 and the camera is fixed. Therefore, even if the orientation of the work vehicle 1 changes, the positional relationship between the working position P1 and the camera 101 in the moving images does not change. As a result, a trained model with high determination accuracy can be easily built. Consequently, the work of a work vehicle 1 can be determined easily and with high accuracy using artificial intelligence.

In the classifying system 100, the computer 102 acquires the image data D11 in which the work vehicle 1 is captured from the camera 101 attached to the vehicle body 2 of the work vehicle 1, and is able to determine the work of the work vehicle 1. Therefore, the work can be determined easily and with good accuracy by attaching the camera 101 even on a work vehicle 1 that is not provided with apparatuses for determining the work such as specific sensors or the like.

In the classifying system 100, the classification of the work is determined from the images of the work vehicle 1 and the work time period of the classification is recorded as management data. Therefore, by capturing the images of the work vehicle 1 in a time sequence, a time study of the work performed by the work vehicle 1 can be performed easily and automatically by the computer 102. In addition, images in a time sequence of each of a plurality of work vehicles 1 at a work site are captured and management data is generated by the classifying system 100, whereby a time study of the work performed by the plurality of work vehicles 1 at the work site can be performed easily and automatically by the computer 102.

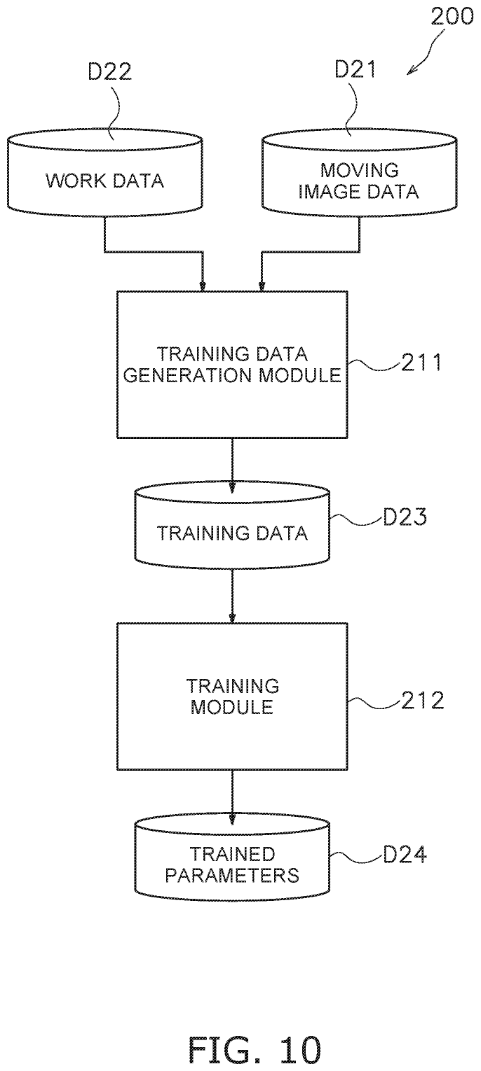

A training method of the classification model 111 according to an embodiment will be explained next. FIG. 10 illustrates a training system 200 for training the classification model 111. The training system 200 is configured by a computer that includes a processor and a storage device in the same way as the abovementioned computer 102.

The training system 200 includes a training data generating module 211 and a training module 212. The training data generating module 211 generates training data D23 from the image data D21 of the work vehicle 1 and work data D22. The image data D21 is acquired from the camera 101 attached to the vehicle body 2 in the same way as the abovementioned image data D11.

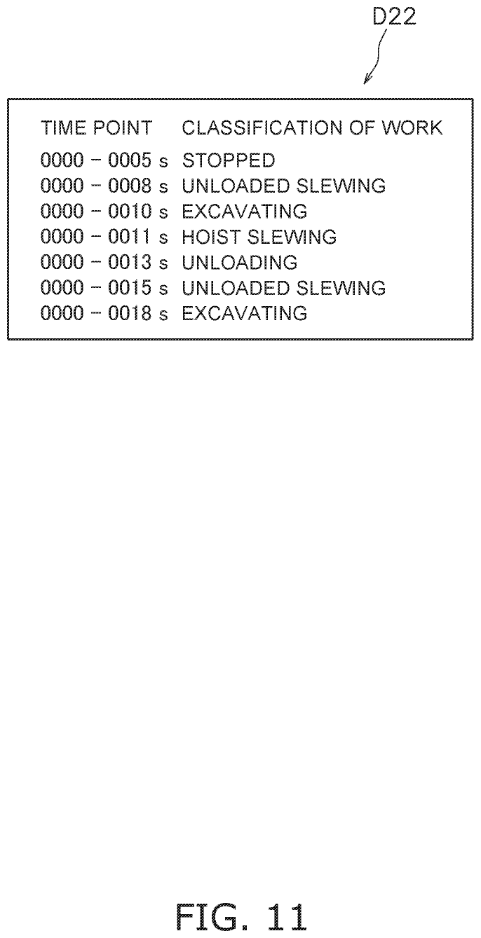

FIG. 11 illustrates an example of the work data D22. As illustrated in FIG. 11, the work data D22 includes time points in the images in the image data D21 and classifications of work ascribed to each of the time points. The ascribing of the classifications may be performed manually.

The classification model 111 for image analysis is prepared in the training system 200. The training module 212 trains the classification model 111 with the training data D23 thereby optimizing parameters of the classification model 111. The training system 200 acquires the optimized parameters as trained parameters D24.

The initial values of each type of parameter of the classification model 111 may be applied with a template. Alternatively, the initial values of the parameters may be applied manually through human input. The training system 200 may perform retraining of the classification model 111. When retraining of the classification model 111 is performed, the training system 200 may prepare the initial values of the parameters based on the trained parameters D24 of the classification model 111 that serves as the object of the retraining.

The training system 200 may update the trained parameters D24 by regularly executing the abovementioned training of the classification model 111. The training system 200 may transfer the updated trained parameters D24 to the computer 102 of the classifying system 100. The computer 102 may update the parameters in the classification model 111 with the transferred trained parameters D24.

Although an embodiment of the present invention has been described so far, the present invention is not limited to the above embodiment and various modifications may be made within the scope of the invention.

The configurations of the classifying system 100 and/or the training system 200 may be modified. For example, the classifying system 100 may include a plurality of computers. Processing performed with the abovementioned classifying system 100 may be distributed among the plurality of computers and executed.

For example, the training system 200 may include a plurality of computers. Processing performed with the abovementioned training system 200 may be distributed among the plurality of computers and executed. For example, the generation of the training data and the training of the classification model 111 may be executed by different computers. That is, the training data generating module 211 and the training module 212 may be loaded into different computers.

The computer 102 may include a plurality of processors. At least a portion of the abovementioned processing may be executed by another processor such as a graphics processing unit (GPU) without being limited to a CPU. The abovementioned processing may be distributed and executed among the plurality of processors.

In the above embodiment, the classification model 111 includes the neural network 120. However, the classification model 111 is not limited to a neural network and may be a model, such as, for example, a support vector machine, that is able to improve the accuracy of the image analysis.

The work vehicle 1 is not limited to a hydraulic excavator and may be another vehicle such as a bulldozer, a wheel loader, or a motor grader, a dump truck, or the like. The classifying system 100 may determine the work of a plurality of work vehicles. The classification model 111, the trained parameter D24, and/or the training data D23 may be prepared for each type of work vehicle 1. Alternatively, the classification model 111, the trained parameter D24, and/or the training data D23 may be common for multiple types of work vehicles 1. In such a case, the classification model 111 may estimate the work of the work vehicle 1 and the type of the work vehicle 1.

The classifying system 100 may have a plurality of cameras 101. The plurality of cameras 101 may capture images of a plurality of the work vehicles 1. The computer 102 may receive the image data D11 from each of the plurality of cameras 101. The camera 101 may acquire still images in a time sequence. That is, the image data D11 may be data indicative of a plurality of still images in a time sequence.

A portion of the classifications of the work may be modified or omitted. Alternatively, other classifications may be further included among the work classifications. For example, the work classifications may include “loading” or “trench excavating.” The actions of the work implement 3 are similar in “loading” and “trench excavating.” As a result, it would be difficult to determine the work with good accuracy in the determination by the abovementioned sensors. However, the work can be determined with good accuracy by determining the work using the classification model 111 from the image data that includes the background of the work implement 3.

A portion of the abovementioned processing may be omitted or modified. For example, the processing for recording the work time period may be omitted. The processing for generating the management data may be omitted.

The abovementioned classification model 111 is not limited to a model trained by machine learning using training data, and may be a model generated by using the trained model. For example, the classification model 111 may be another trained model (derived model) in which the accuracy is further improved by further training the trained model using new data. Alternatively, the classification model 111 may be another trained model (distilled model) that is trained based on results obtained by repeatedly inputting and outputting data into the trained model.

According to the present invention, the work performed by a work vehicle can be determined easily and with high accuracy using artificial intelligence.

1. A system for determining work executed by a work vehicle that includes a vehicle body and a work implement movably attached to the vehicle body, the system comprising:
a camera attached to the vehicle body, the camera being disposed to be oriented from the vehicle body toward a working position of the work implement, and the camera generating image data indicative of images of the working position captured in a time sequence; and
a processor having a trained model in order to output a classification of the work corresponding to the image data the image data serving as input data, and the processor being configured to
acquire the image data, and
determine the classification of the work from the image data by image analysis using the trained model.

2. The system according to claim 1, wherein
the work implement includes an arm and a bucket rotatably attached to the arm, and
the image data includes video of actions of the bucket.

3. The system according to claim 1, wherein
the classification of the work includes excavating.

4. The system according to claim 2, wherein
the classification of the work includes unloading.

5. The system according to claim 1, wherein
the vehicle body includes a carriage and a slewing body that is attached to the carriage in a manner that allows slewing,
the camera is attached to the slewing body, and
the image data includes video of the bucket and background of the bucket that changes due to the slewing of the slewing body.

6. The system according to claim 5, wherein
the classification of the work includes hoist slewing.

7. The system according to claim 5, wherein
the classification of the work includes unloaded slewing.

8. The system according to claim 1, wherein
the image data represents moving images in which images of the working position are captured.

9. A method executed by a computer for determining work executed by a work vehicle that includes a vehicle body and a work implement movably attached to the vehicle body, the method comprising:
acquiring image data indicative of images of a working position captured in a time sequence from a camera, the camera being fixedly disposed relative to the vehicle body and oriented toward the working position of the work implement; and
determining a classification of the work from the image data by image analysis using a trained model that outputs the classification of the work corresponding to the image data the image data serving as input data.

10. The method according to claim 9, wherein
the work implement includes an arm and a bucket rotatably attached to the arm, and
the image data includes video of actions of the bucket.

11. The method according to claim 10, wherein
the classification of the work includes excavating.

12. The method according to claim 10, wherein
the classification of the work includes unloading.

13. The method according to claim 9, wherein
the vehicle body includes a carriage and a slewing body that is attached to the carriage in a manner that allows slewing,
the camera is attached to the slewing body, and
the image data includes video of the bucket and background of the bucket that changes due to the slewing of the slewing body.

14. The method according to claim 13, wherein
the classification of the work includes hoist slewing.

15. A method for producing a trained model for determining work executed by a work vehicle that includes a vehicle body and a work implement movably attached to the vehicle body, the method comprising:
acquiring image data indicative of images of a working position captured in a time sequence and oriented from the vehicle body toward the working position of the work implement;
generating work data that includes time points in the images and a classification of the work ascribed at each time point; and
building the trained model by training a model for image analysis using the image data and the work data as training data.
